(19) United States
(12) Patent Application Publication
(10) Pub. No.: US 2026/0355745 A1
(43) Pub. Date: Nov. 12, 2026

(54) INSTRUMENT, SYSTEM AND METHOD FOR DROPLET MANIPULATION

(71) Applicant: IMEC VZW, Leuven (BE)

(72) Inventors: Chengxun Liu, Heverlee (BE); Murali Jayapala, Kumtich (BE); Ziduo Lin, Heverlee (BE); Abdulkadir Yurt, Korbeek-Lo (BE)

(21) Appl. No.: 19/129,661

(22) PCT Filed: Nov. 14, 2023
(86) PCT No.: PCT/EP2023/081755

§ 371 Date: May 13, 2025

(30) Foreign Application Priority Data
Nov. 15, 2022 (EP) 22207397.5

(51) Int. Cl. B01L 3/00

(52) U.S. Cl. CPC B01L 3/502792; B01L 2200/0673; B01L 2200/143; B01L 2400/0427

(57) ABSTRACT

The disclosure relates to an instrument for droplet manipulation including a driving module configured for receiving control signals and for operating an electrowetting-on-dielectric chip configured for manipulating a droplet. A droplet detection system including a light source and a lens-free imaging device configured for obtaining at least one image including the droplet in the electrowetting-on-dielectric chip, and a control unit configured for receiving the at least one image from the droplet detection system and for sending control signals to the driving module. The control unit is further configured to adapt at least one of the control signals as a function of the at least one image. The present disclosure also relates to a system comprising the instrument, and an electrowetting-on-dielectric chip configured to receive signals from the driving module.

### TECHNICAL FIELD

The present invention is generally related to an instrument, system and method for droplet manipulation and more specifically to an instrument, system and method for droplet manipulation via electrowetting-on-dielectric (EWOD).

### TECHNICAL BACKGROUND

Droplet manipulation has crucial commercial and scientific potential for many biomedical applications. The current state of droplet manipulation is limited in terms of throughput, cost and functionality.

One known technique for tracking droplets on an EWOD chip is explained in document WO2016/174523 A1 by D. Cyril et al.

### SUMMARY OF THE INVENTION

The invention is set out in the appended set of claims.

It is an objective of the invention to at least partly overcome the limitations of the prior art. In particular, it is an object to provide an instrument, system and method for efficient droplet manipulation.

In a first aspect, the present invention relates to an instrument for droplet manipulation comprising: a driving module configured for receiving control signals and for operating an electrowetting-on-dielectric (EWOD) chip, wherein the electrowetting-on-dielectric chip is configured for manipulating a droplet; a droplet detection system comprising a light source and a lens-free imaging (LFI) device configured for obtaining at least one image comprising the droplet in the electrowetting-on-dielectric chip; and a control unit configured for receiving the at least one image from the droplet detection system and for sending control signals to the driving module; wherein the control unit is further configured to adapt at least one of the control signals as a function of the at least one image. The instrument of the first aspect has several advantages. First, the lens-free imaging device can capture microscopy images in a large field-of-view (FOV) therefore a plurality of droplets can be continuously and automatically monitored and manipulated in parallel. Second, the images captured by the lens-free imaging device enables adjustment and adaptation of one or more subsequent control signals to manipulate the droplets. Third, the instrument is compatible with various and customized EWOD chips.

Any feature of the first aspect may be as correspondingly described in the second aspect.

In a second aspect, the present invention relates to a system comprising the instrument, and further comprising an electrowetting-on-dielectric chip, preferably in a replaceable cartridge, configured to receive signals from the driving module. The system has the advantage of compatibility with various replaceable cartridges. According to an example embodiment, the replaceable cartridge is a disposable cartridge. According to an example embodiment, the replaceable cartridge is a reusable cartridge.

According to an example embodiment, the at least one of the adapted control signals is for instructing the driving module to move the droplet to a predetermined location. It is an advantage of this example embodiment that the control unit automatically determines a path for moving the droplet to the predetermined location based on the images captured by the lens-free imaging device.

According to an example embodiment, the control unit is configured to extract the location of the droplet from the at least one image, wherein the at least one of the control signals is adapted based on the location. This has the advantage of allowing the locations of a plurality of droplets to be captured in the image, as well as EWOD pixels where no droplet is located.

According to an example embodiment, the control unit is configured to adapt the control signals so that if the movement of the droplet differs from a predetermined first path after a first control signal, at least a subsequent control signal is sent to move the droplet along a second path, different from the first path, to the predetermined location. It is an advantage of this example embodiment that the path for moving the droplet to a predetermined location can be adapted and changed to a different path during the movement of the droplet.

According to an example embodiment, the at least one image comprises a holographic image. It is an advantage of this example embodiment that the control signal can be adapted based on the raw data, i.e. hologram, from the lens-free imaging device. This allows rapid adaptation on the control signal by the control unit based on the hologram captured by the lens-free imaging device, as the processing speed on the hologram is not constrained by the computation kernel.

According to an example embodiment, the at least one image comprises a two-dimensional (2D) or a three-dimensional (3D) image. According to an example embodiment, the 2D or 3D image may be a reconstructed image from the raw data, i.e. a hologram. According to an example embodiment, the 2D or 3D image may be captured by a different imaging device. It is an advantage that the 2D or 3D image comprises further information than the hologram. The control signal can therefore be adapted as a function of reconstructed images.

According to an example embodiment, the control unit is configured to adapt at least one of the control signals as a function of at least one variable obtained by the control unit from the at least one image, each of said at least one variable representing a different property selected from one or more of a size, shape, spectral absorbance, spectral transmittance, turbidity, viscosity and a spatial distribution of the at least one aforementioned properties of the droplet. It is an advantage that the properties including morphology of the droplet are captured by the lens-free imaging device in at least one image. The properties captured in images can be further used as variable(s) for adapting the control signals.

According to an example embodiment, the at least one of the control signals is adapted for instructing the driving module to mix at least two droplets into one droplet.

According to an example embodiment, the control unit is configured to adapt at least one of the control signals to continue or stop the mixing of droplets as a function of at least one variable obtained by the control unit from the at least one image, the said at least one variable representing a spatial distribution of at least a property or a combination of properties selected from one or more of a size, shape, spectral absorbance, spectral transmittance, turbidity and viscosity of the droplet. According to an example embodiment, the image is a 3D image. It is an advantage that the image or the images can be used to mix or merge the droplets to reach homogeneity automatically.

According to an example embodiment, the control unit is configured to adapt at least one of the control signals as a function of at least one variable obtained by the control unit from the at least one image, each of said at least one variable representing an object in the droplet. It is an advantage that a feature, i.e. an object, in the droplet image is captured by the lens-free imaging device in at least one image. The features in the image can be further used as variable(s) for adapting the control signals.

According to an example embodiment, the object is a cell. It is an advantage that particles such as cells in the droplet can be captured in the image. Such particle in the image can be further used as variable(s) for adapting the control signals.

According to an example embodiment, the object is an air bubble. It is an advantage that defects such as air bubbles can be captured in the image. Such defects in the image can be further used as variable(s) for adapting the control signals.

According to an example embodiment, the object is a different non-soluble droplet, i.e., a further droplet not soluble in the droplet. It is an advantage that the properties of the droplet and the different droplet therein can be extracted. It is an advantage that any difference of the at least two droplets can be captured by the lens-free imaging device in at least one image. Such difference in the image can be further used as variable(s) for adapting the control signals.

According to an example embodiment, the control unit is configured to adapt at least one of the control signals as a function of at least one variable obtained by the control unit from the at least one image, each of said at least one variable representing a different defect in the electrowetting-on-dielectric chip. It is an advantage of this example embodiment that the image captures defects on the EWOD chip as well. These defects indicate malfunctioning locations on the EWOD chip. Therefore, the control signal can be adapted to avoid such locations when manipulating the droplet.

According to an example embodiment, the electrowetting-on-dielectric chip comprises a plurality of electrowetting-on-dielectric layers, wherein the control unit is configured to adapt at least one of the control signals as a function of at least one variable obtained by the control unit from a plurality of holographic images by using focus adjustment, each of said at least one variable representing whether a droplet is present in a different electrowetting-on-dielectric. It is an advantage that the droplets can be manipulated in parallel simultaneously on a plurality of stacked EWOD layers. This allows for more efficient and faster droplet manipulation.

Any feature of the second aspect may be as correspondingly described in the first aspect.

In a third aspect, the present invention relates to a method for droplet manipulation in the instrument according to embodiments of the description, comprising the steps of: a. causing the control unit (104) to receive at least one image comprising a plurality of droplets; b. causing the control unit (104) to generate control signals for manipulating the droplets simultaneously by electrowetting as functions of the received at least one image. It is an advantage that a plurality of droplets is manipulated simultaneously using such method.

According to an example embodiment, at least 1,000 droplets are manipulated simultaneously using such a method. According to an example embodiment, at least 10,000 droplets are manipulated simultaneously using such a method.

Any feature of the third aspect may be as correspondingly described in the first or second aspect.

In a fourth aspect, the present invention relates to a computer program comprising instructions to cause the instrument according to the first aspect to execute the steps of the method according to the third aspect.

In a fifth aspect, the present invention relates to a computer-readable medium having stored thereon the computer program of the fourth aspect.

### BRIEF DESCRIPTION OF THE DRAWINGS

FIG. 1 shows a block diagram of a first example showing an instrument for droplet manipulation in combination with a top-down view of an EWOD chip.

FIG. 2 shows a block diagram of a second example of a system for droplet manipulation, and a side view of an EWOD chip.

FIG. 3 shows a block diagram of a third example of a system for droplet manipulation, and illustrations of images of droplets in hologram and in reconstructed images.

FIG. 4 shows a block diagram of a fourth example of a system for droplet manipulation, and illustrations of images of extracted properties of the droplets.

FIG. 5 shows block diagram of a fifth example of a system for droplet manipulation, and illustrations of images of extracted properties of the droplets captured with time intervals.

FIG. 6 shows block diagram of a sixth example of a system for droplet manipulation, and illustrations of images of droplets with an object therein.

FIG. 7 shows block diagram of a seventh example of a system for droplet manipulation, and illustrations of images of droplets with air bubbles as defects.

FIG. 8 shows block diagram of an eighth example of a system for droplet manipulation, and a side view of an EWOD chip with two EWOD layers.

FIG. 9 shows a zoomed-in illustration of the droplet detection system and the EWOD chip of a nineth example of a system for droplet manipulation.

FIG. 10 shows a zoomed-in illustration of solution loading on EWOD chip.

FIG. 11 shows a zoomed-in illustration of droplet generation process.

### DETAILED DESCRIPTION

The disclosure will be further elucidated by means of the following description and the appended figures. Various exemplary embodiments are described herein with reference to the following figures, wherein like numeral denotes like entities. The figures described are schematic and are non-limiting. Further, any reference signs in the claims shall not be construed as limiting the scope of the present disclosure. Still further, in the different figures, the same reference signs refer to the same or analogous elements.

The term “comprising”, used in the claims, should not be interpreted as being restricted to the means listed thereafter; it does not exclude other elements or steps. It is thus to be interpreted as specifying the presence of the stated features, integers, steps, or components as referred to, but does not preclude the presence or addition of one or more other features, integers, steps or components, or groups thereof. The term “comprising” therefore covers the situation where only the stated features are present (and can therefore always be replaced by “consisting of” in order to restrict the scope to said stated features) and the situation where these features and one or more other features are present. The word “comprising” according to the invention therefore also includes as one embodiment that no further components are present. Thus, the scope of the expression “a device comprising means A and B” should not be interpreted as being limited to devices consisting only of components A and B. It means that with respect to the present invention, the only relevant components of the device are A and B.

The term “a” shall be interpreted as a function word before a mass noun to denote a particular type or instance. It should not be interpreted as a function word before a singular noun referring one object.

The term “instrument” refers to a tool or an apparatus designed for droplet manipulation.

A droplet refers to a volume of a first fluid of 30 picolitre to 100 micro liter in a second fluid where the first and the second fluids are immiscible. According to an example embodiment, the first fluid is aqueous, and the second fluid is oil based, such as silicone oil. According to an example embodiment, the droplet can further comprise particles and/or objects, such as biological cell, air bubbles, another droplet, etc. Droplet manipulation generally refers to actions applied to droplets, including and not limited to: changing the location of the droplet(s), interacting droplets and causing a change of a property of droplet(s).

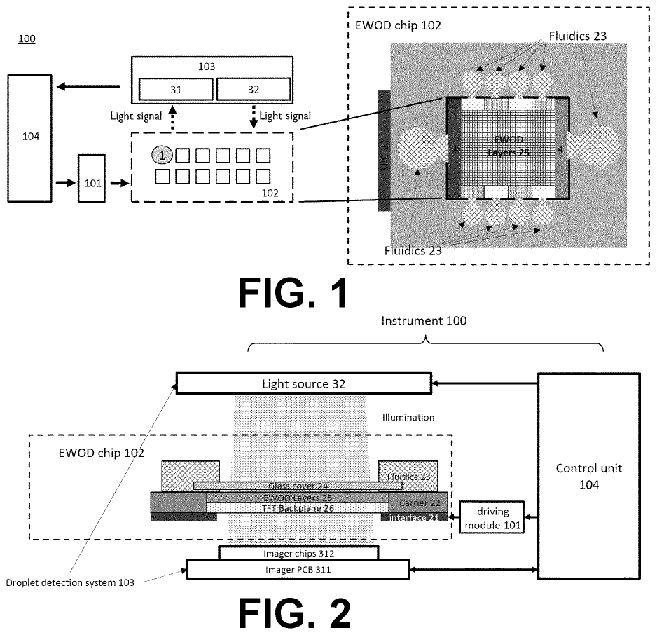

As shown in FIG. 1, the present invention relates to an instrument (100) comprising a driving module (101), a droplet detection system (103) and a control unit (104). The instrument (100) is compatible for use with an EWOD chip (102).

An example EWOD chip as shown in FIG. 2 comprises an EWOD layer (25), a transparent cover (24), and a thin-film transistor (TFT) backplane (26). The EWOD layer (25) and the transparent cover (24) leave a distance therebetween, creating an operation space where the droplets are manipulated and the fluid around droplets is placed. The operation space can be referred as an electrowetting layer. The operation space usually has a height of 10 to 1000 μm to allow droplet manipulation. According to an example embodiment, the transparent cover (24) is a glass cover. According to an example embodiment, the EWOD chip further comprises fluidics such as reservoirs to provide the droplets and the fluids. According to an example embodiment, the reservoirs contain bio-chemical materials such as cell medium, buffers, oils, water, etc. According to an example embodiment, the bio-chemical materials can be supplied by an attached fluidic pump to the reservoirs or can be supplied via pipettes, manually or automatically. Such bio-chemical materials can be contained in tubes, containers, plates, syringes which, for example, are attached to the fluidic pump.

The EWOD chip further comprises an electronic interface (21) configured for receiving the control signals from the driving module (101). The EWOD layer (25) comprises an electrode array. The TFT backplane comprises electronic connections between the driving module (101) and each electrode in the electrode array. The TFT backplane has electrode pins to establish an electrical connection with the instrument. The droplets are manipulated by the electrode such that the wetting properties of the droplet are modified and the contact angle of a droplet on the surface of the EWOD chip is changed due to electrostatic effects controlled by the electrode array. The EWOD chip can further comprise carrier(s) for supporting purpose.

According to an example embodiment, the driving module (101) comprises an electronic interface compatible with the corresponding electronic interface on the EWOD chip. Such driving module (101) receives control signals from the control unit. According to an example embodiment, the driving module (101) is a general computer, an ASIC chip or an FPGA module.

The instrument (100) comprises a droplet detection system (103). The droplet detection system (103) comprises a lens-free imaging device (31). The term “lens-free imaging device” can be interchangeable with “lens-free holographic imaging device”. According to an example embodiment, the droplet detection system (103) further comprises one or more other imaging devices such as a CCD camera and/or fluorescent detector. The droplet detection system comprises a light source (32) for emitting light onto an illumination zone on the EWOD chip. According to an example embodiment, the light source is configured for illuminating at least part of the EWOD chip top surface. The top surface usually refers to the surface of the EWOD chip receiving the light from the light source. According to an example embodiment, the top surface is the transparent cover. According to another example embodiment, the top surface is the TFT backplane. Because the EWOD chip is substantially transparent to light, a top surface or a bottom surface can be interchangeable in context. The EWOD chip is placed at an intermediate point along a path of the light between the light source and the lens-free imaging device (31). The glass cover (24), the operation space, the EWOD layer (25), and the TFT backplane (26) are substantially transparent such that the light emitted from the light source can be detected by the lens-free imaging device (31). The lens-free imaging device (31) comprises an imager chip (312) and an imager PCB (311). According to an example embodiment, the time resolution of the lens-free imaging device can be less than or equal to one millisecond.

An example lens-free imaging device (31) has a field-of-view (FOV) of 20 mm². The illumination zone is larger or equal to the FOV of the lens-free imaging device (31). According to an example embodiment, the droplet detection system (103) comprises a plurality of lens-free imaging devices.

The lens-free imaging device (31) captures at least one raw hologram image of at least a part of the illumination zone. The hologram image is captured for the entire FOV. It comprises a diffraction pattern over the FOV and the corresponding diffraction pattern to the droplet of interest in the EWOD chip (102). The hologram images can be further reconstructed to 2-dimensional (2D) and/or 3-dimensional (3D) images. According to an example embodiment, the droplet detection system comprises a processing unit configured for reconstruction of the hologram image to a 2D and/or 3D image.

The control unit (104) receives at least one image from the droplet detection system. According to an example embodiment, the image is a hologram image. According to an example embodiment, the image is a reconstructed 2D or 3D image. According to an example embodiment, the control unit (104) comprises a central processing unit for processing the images received from the droplet detection system. According to an example embodiment, the central processing unit is configured for reconstruction of the hologram image to a 2D and/or 3D image. According to an example embodiment, the central processing unit is in a general-purpose computer.

The control unit (104) sends control signals to the driving module (101) to instruct the electrodes in the EWOD chip. The control signal instructs the electrodes to modify the contact angle of the droplet on EWOD layer, therefore the droplet is controlled by the electrostatic effects conducted by the electrodes. The control signal can be, but not limited to, to displace a droplet, to split a droplet, to dispense a droplet, to merge droplets, . . . .

At least one of these control signals is adapted as a function of the at least one image.

Features captured in the image are used as variables in a function for adapting the control signals. According to an example embodiment, the feature is the location of the droplet captured in the image. According to an example embodiment, such feature can be at least one parameter of the interrelation of at least two droplets captured in the image, such as a distance. According to an example embodiment, such feature can be at least one parameter of a property of the droplet extracted from the received hologram image corresponding to the diffraction pattern of the droplet of interest. According to an example embodiment, a plurality of features is taken into account as variables for adapting the control signals.

According to an example embodiment, the control unit (104) is configured to extract the location of the droplet from the at least one image, wherein the at least one of the control signals is adapted based on the location.

The electrodes can be damaged either during fabrication or during operation. The damage can be either partial breakdown of the hydrophobic coating or the dielectric layer. It can also be a complete dielectric breakdown. According to an example embodiment, during operation, the control unit (104) sends control signals to instruct the droplet to be displaced along a first path to a predetermined location. When the droplet movement differs from the predetermined path defined by the control unit, a malfunctioning electrode is detected. The control unit (104) will design a second path which is different from the first path, to the predetermined location and adapt the subsequent control signals to guide the droplet along the second path. So that the droplet is still delivered to the predetermined location but avoid using a path via the malfunctioning electrode. The malfunctioned electrode refers to the electrodes that cannot properly modify the wetting properties of the droplet of interest for it to be moved over the said electrode. The malfunction of an electrode can be caused by damage of the electrode itself or the electric circuit couple to the electrode.

According to an example embodiment, during operation, the control unit (104) sends control signals to instruct the droplet to be displaced along a first path to a predetermined location but the last electrode, i.e. the predetermined location, is malfunctioning. The control unit (104) will allocate the droplet to a second location which is different than the predetermined location. According to an example embodiment, the predetermined location is in a predetermined area and the second location can be a different location in the same predetermined area which is not yet allocated for another droplet.

According to an example embodiment, the control unit (104) is configured to perform an EWOD inspection for defects. The control unit (104) will adapt at least one of the control signals as a function of at least one variable obtained by the control unit (104) from the at least one image, each of said at least one variable representing a different defect in the electrowetting-on-dielectric chip (102). According to an example embodiment, the defect is damage to the dielectric layer. For example, when dielectric breakdown results in a pinhole in the device, the damaged area including the electrode is visible in the captured image, such as the edge of a missing piece of the dielectric layer or a different gray scale of the missing piece of the dielectric layer compared to the surrounding undamaged layer. In another example, when a small area of the hydrophobic or dielectric layer is delaminated, the resultant thickness variation can be visualized in the captured image showing a different local optical density compared to the functioning electrode. The optical density difference of or around the electrode can be a variable for adapting at least one subsequent control signal. According to an example embodiment, such EWOD inspection can be done before any droplets being loaded to the EWOD chip. In such a way, all control signals are adapted to avoid using the damaged area and malfunctioning electrode during operation. According to an example embodiment, such EWOD inspection can be done during operation such that any breakdown of the electrode can be observed in time. Control signals are adapted during operation with the detected defects in EWOD inspection.

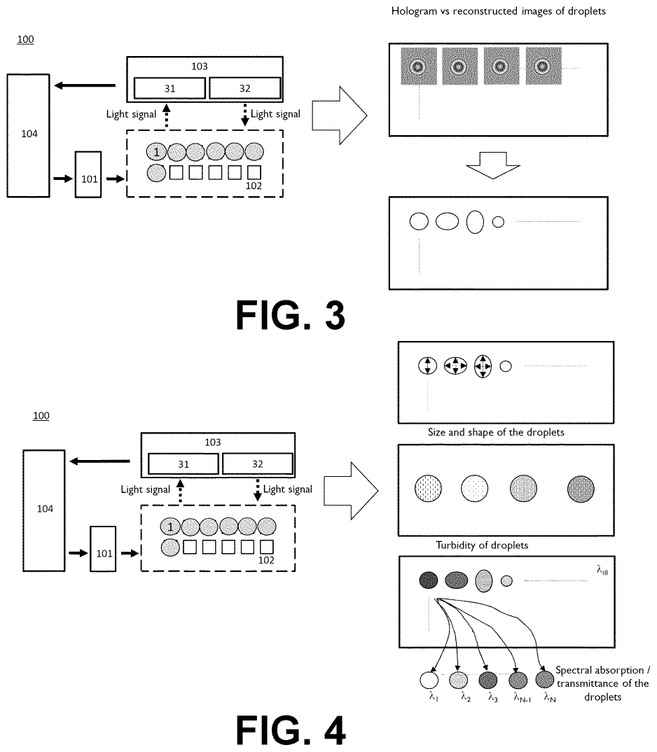

As shown in FIG. 3, the light source (32) in the droplet detection system (103) emits light to the illumination zone on the EWOD chip (102). The lens-free imaging device (32) captures hologram images from the interference of light. The control unit (104) receives hologram images and/or reconstructed 2D/3D images from the droplet detection system (103). At least one control signal is adapted as a function of the at least one image. The control signals are sent to the EWOD chip (102). Exemplar figures are given for the hologram image and the reconstructed 2D image of droplets of interest.

According to an example embodiment, the image is a hologram image. Features captured in a raw hologram image, such as the location, size, shape, refractive index, turbidity of the droplet etc. These features can be found through a supervised model or analytical model developed on the holograms. can be used directly as variables for adapting the control signals. This allows fast adaptation of the control signal because the speed of processing is not constrained by the computation kernel which is required by the reconstruction process.

According to an example embodiment, the image is a reconstructed image from the hologram image. The reconstruction processing entails numeric calculations on the two-dimensional images obtained from the image sensor. Such numeric calculations include, for instance, deconvolutions, the wave or beam propagation, transformations (such as Fourier Transforms), two-dimensional filtering operations such as denoising, etc. The reconstructed image reveals physical features of the droplet.

According to an example embodiment, the control unit (104) receives both hologram images and reconstructed images.

According to an example embodiment, the image can be processed as a whole. According to an example embodiment, the image can be divided into sub areas and the sub areas are processed individually. The processing can be therefore performed in parallel for different sub areas.

The instrument (100) is compatible to be used with an EWOD chip. According to an example embodiment, the EWOD chip is in a replaceable cartridge. The cartridge is reusable or disposable. When the cartridge is a disposable device, the instrument (100) can be used with a plurality of cartridges one after another for a plurality of experiments. When the cartridge is reusable, the cartridge can be optionally primed between the experiments. The priming step ensures that the surface properties of the EWOD chip are restored. According to an example embodiment, the instrument (100) provides a mechanical slot where the cartridge can be installed by the user to the instrument. The EWOD chip is configured to receive signals from the driving module (101) of the instrument (100). The EWOD chip comprises a corresponding electronic interface to communicate with the driving module (101).

According to an example embodiment, at least one of the adapted control signals is for instructing the driving module (101) to move the droplet to a predetermined location. The detection of a feature or a change of a feature can be used as a triggering event to send the droplet to the predetermined location and group droplets in a predetermined area.

As shown in FIG. 4, the light source (32) in the droplet detection system (103) emits light to the illumination zone on the EWOD chip (102). The lens-free imaging device (32) captures hologram images from the interference of light. The control unit (104) receives hologram images and/or reconstructed 2D/3D images from the droplet detection system (103). At least one control signal is adapted as a function of the at least one image. According to an example embodiment, the whole image containing multiple droplets can be processed for adapting subsequent control signals. According to an example embodiment, the raw hologram image can be split into predefined sub areas where droplets are present. These sub areas can be independently processed. The control unit (104) can send control signals to the sub areas.

The control signals are sent to the EWOD chip (102). Exemplar figures are given for properties of the droplet of interest such as the size, shape, spectral transmittance, spectral absorbance, and turbidity and the spatial distribution of some of these properties within a droplet. Any of these features or a combination thereof can be used as a variable for adapting the control signals.

According to an example embodiment, the control unit (104) is configured to adapt at least one of the control signals as a function of at least one variable obtained by the control unit (104) from the at least one image, each of said at least one variable representing a different property selected from the size, shape, spectral absorbance, spectral transmittance, turbidity, and viscosity of the droplet.

According to an example embodiment, the at least one of the adapted control signals is adapted for instructing the driving module (101) to mix at least two droplets into one droplet.

According to an example embodiment, the control unit (104) is configured to adapt at least one of the control signals to continue or stop the mixing droplets as a function of at least one variable obtained by the control unit (104) from the at least one image, the said at least one variable representing a spatial distribution of at least a property or a combination of properties selected from one or more of a size, shape, spectral absorbance, spectral transmittance, turbidity and viscosity of the droplet. According to an example embodiment, “droplet mixing” refers to the process of droplet merging by mixing the droplets via electrowetting. In certain context, “droplet mixing” is interchangeable with “droplet merging”.

According to an example embodiment, the dimensions of the droplet of interest can be extracted from the images. According to an example embodiment, predetermined values, optionally with margin values, can be stored in the control unit and compared with the measured dimensions of the droplet. If the dimension of the droplet is not as desired, the droplet can be moved to a predetermined location for further investigation.

According to an example embodiment, the shape of the droplet of interest can be extracted from the images. According to an example embodiment, the volume of the droplet can be estimated. According to an example embodiment, surface shape of the droplet can be estimated from the diffraction patterns captured in the 3D images of the droplet. The estimated surface shape provides indication of surface tension of the droplet and therefore wetting properties can be estimated from the 3D images. Any of these features or a combination thereof can be used as a variable for adapting the control signals.

According to an example embodiment, spectral absorbance or transmittance of droplets can be revealed from the images. As the droplet scatters and/or absorbs the light to be detected by the lens-free imaging device (31), diffraction effects can be quantified by reconstructing the fringe pattern of the hologram. The attenuation coefficient of the droplet solution can therefore be estimated and used as a variable for adapting the control signals.

The absorption of the droplet solution can be spectrally dependent. The absorption properties of the light can differ at distinct wavelengths in the visible and NIR spectral range (image sensor sensitivity). According to an example embodiment, the light source (32) can apply a plurality of different wavelengths and lens-free imaging device (31) captures hologram images at different wavelengths. The reconstructed image of the droplet at different wavelengths reveals the spectral absorption of droplets. According to an example embodiment, the dilution of a substance inside the droplet is a feature. According to an example embodiment, the presence or absence of a certain soluble substance that has a chemical property to absorb the light at certain spectral window width ranging from 1 nm to 500 nm can be estimated as a feature. According to an example embodiment, changes of the absorption to monitor a chemical or biological reaction inside the droplet during a predetermined time period can be observed as a feature. Any of these features or a combination thereof can be used as a variable for adapting the control signals.

According to an example embodiment, the light source (32) comprises multiple sub light sources illuminating the droplets at unique and distinct wavelengths. According to an example embodiment, a single light source is used for illuminating at multiple and distinct wavelengths.

According to an example embodiment, the turbidity properties can be evaluated from the images. The cloudiness and haziness caused by the first fluid in the droplet can be detected as the light from the droplet would be scattered and this will lead to a pattern of diffraction. The degree of turbidity can be correlated with respect to an optical feature hologram image or the reconstructed image of the hologram image. The degree of turbidity can be defined in, for example, Formazin Nephelometric Unit (FNU) or Nephelometric Turbidity Unit (NTU). According to an example embodiment, the turbidity properties can be used to estimate the non-soluble content inside, such as solution cleanliness and particulate concentration. According to an example embodiment, it can be also used to estimate time evolution of the non-soluble content of the droplet. According to an example embodiment, statistical data obtained from turbidity can be used to track the evolution of a chemical or biological reaction inside the droplet. Any of these features or a combination thereof can be used as a variable for adapting the control signals.

According to an example embodiment, a set of pre-determined feature values related to the characteristics of the droplet, such as volume and viscosity of the droplet etc., is stored as reference values with margin. In operation, when the feature values exceed the margin, the features can be used for adapting a subsequent control signal to tune the EWOD parameters such as voltage or frequency to be applied on electrode.

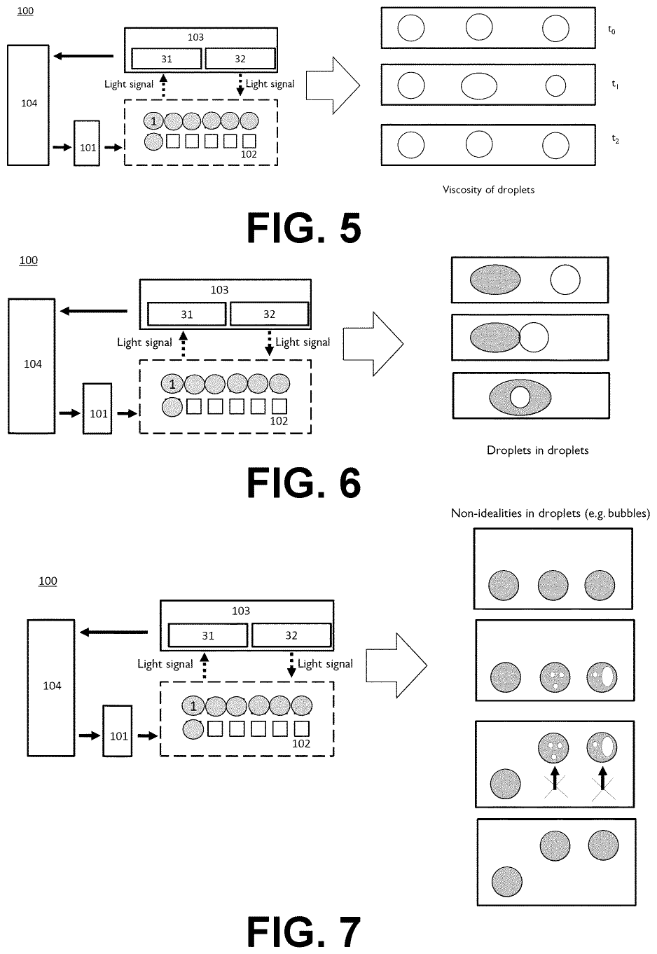

According to an example embodiment, some properties or features can be measured over a time interval as shown in FIG. 5. The property can be of a droplet, such as viscosity, shape, and volume. The property can also be of interaction between the droplets such as stability of the droplets. For example, merging similar or different mediums in the form of droplets or splitting droplets can be thus analyzed in high temporal and spatial resolution.

According to an example embodiment, features inside the droplet are also captured in the images, such as an object or a plurality of objects. According to an example embodiment, the object can be, but not limited to, a biological entity such as cell, molecule, molecule fragment, etc. The biological cell refers to a structural and functional unit of life form such as a cell formed with a cytoplasm enclosed within a membrane, which contains many biomolecules such as proteins and nucleic acids. The molecule refers to biological molecules such as RNA, DNA, protein, etc. The molecule fragment can be RNA fragment, DNA fragment, peptide, etc. According to an example embodiment, the characteristics of the biological cell can be captured in the images such as the size, shape, spectral absorbance, spectral transmittance, etc. According to an example embodiment, the characteristics of the biological cell can be captured in the images over a time interval, such as the cell's growth and development, etc. According to an example embodiment, the characteristics of the biological cell can be captured in the images when responding to a biological entity, such as cell reacting to a certain chemical, inter-cell reaction, etc.

According to an example embodiment, unexpected objects, such as air bubbles, micelles, or other liquid phase irregularities, are captured in the image, as shown in FIG. 7. The unexpected objects can indicate that the electrode having contact with the droplet is not properly functioning. The electrode may malfunction in the future. According to an example embodiment, the control signal is adapted to send the droplet which is currently having contact with the electrode to a neighboring electrode. According to an example embodiment, the control signal is adapted to avoid using this electrode for displacing other droplets. Any designed paths for other droplets are recalculated and redesigned. Additionally, the electrode may be switched off by the control unit (104).

According to an example embodiment, the object can be another droplet. According to an example embodiment, the control signal can be adapted to manipulate the droplet based on the difference in characteristics of the two droplets captured in the images. According to an example embodiment, the control signal can be adapted to manipulate the droplet based on the changes in characteristics of the two droplets over a time interval which is captured in the images.

According to an example embodiment, the EWOD chip comprises a plurality of EWOD layers. Each layer is functioning individually and can be controlled by the control unit (104) individually and in parallel.

According to an example embodiment, the TFT backplane, EWOD layer and the glass cover forms an EWOD sub operation unit where a plurality of the EWOD sub operation units is stacked on top of each other. According to an example embodiment, the control unit (104) may have sub control module for controlling each EWOD sub operation unit. The lens-free imaging device (31) can image through a plurality of the stacked EWOD sub operation units without mechanical focusing or movements. The focus adjustments are done digitally from a recorded hologram to focus on multiple layers simultaneously. The control signal is adapted individually for droplets in each EWOD layer.

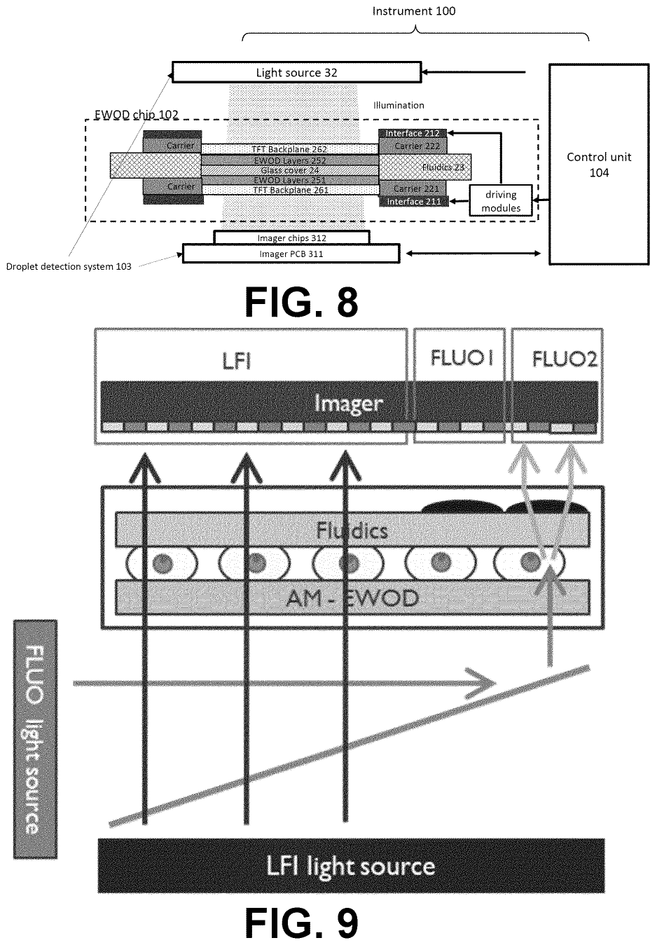

According to an example embodiment, a preferred arrangement for dual-layer EWOD chip is shown in FIG. 8. The EWOD chip comprises a glass cover (24) and a first EWOD layer (251) forming a first operation space therebetween. A first TFT backplane (261) is coupled to the first EWOD layer (251). The EWOD chip further comprises a second EWOD layer (252) forming a second operation space between the second EWOD layer (252) and the glass cover (24). The EWOD chip further comprises a first and a second carriers (221, 222) for supporting the corresponding first and second TFT backplanes (261, 262) and first and second electronic interfaces (211, 212) for receiving control signals from the driving modules of the instrument (100). The first and second electronic interfaces (211, 212) are electronically coupled to the corresponding first and second TFT backplanes. The fluidics (25) can be shared for supplying fluids to the first and second operation spaces. In operation, the light source (32) emits light on the EWOD chip forming an illumination zone on the EWOD chip. A lens-free imaging device in a droplet detection system (103) comprises imager chips (312) and an imager PCB (311) that detects light and captures a hologram image. The control unit (104) receives images from the droplet detection system (103) and adapts control signals to be sent to the driving modules as a function of the received image. When the image is taken for the droplets in the first operation space, the adapted control signals based on the image are sent to the first interface (211). When the image is taken for the droplets in the second operation space, the adapted control signals based on the image are sent to the second interface (211). According to an example embodiment, the two EWOD layers will share a common ground electrode. According to an example embodiment, the corresponding TFT backplanes for the two EWOD layer are driven from two distinct controllers, i.e., in parallel and independently, in the control unit (104). According to an alternative example embodiment, they can be driven from a single controller in a time multiplexed fashion, i.e. in time switched fashion. This could be advantageous to reduce the cost.

According to an example embodiment, the control unit (104) sends control signals to the droplet detection system (103) to instruct the lens-free imaging device (31) to sweep in an area or sub area in the illumination zone.

According to an example embodiment, the droplet detection system (103) further comprises a fluorescent detector (FLO1 and FLO2) as shown in FIG. 9. Fluorescent detection requires a fluorescent light source. According to an example embodiment, the light source (32) comprises a first sub light source for lens-free imaging and a second sub light source for fluorescent detection. The light source (32) can further comprises a one-way mirror such that the first sub light source is transmitted through a first side of the mirror to the EWOD chip and the second sub light source is reflected at a second side of the mirror to the EWOD chip.

In the third aspect, the invention relates to a method of droplet manipulation. According to an example embodiment, at least two droplets with adapted control signals are manipulated simultaneously. The control signals to each of the at least two droplets are adapted as function of the received at least one image. According to an example embodiment, at least a hundred droplets are manipulated with adapted control signals as functions of the images. According to an example embodiment, at least a thousand droplets are manipulated with adapted control signals as functions of the images. According to an example embodiment, at least a million droplets are manipulated with adapted control signals as function of the images.

According to an example embodiment, an assay is assigned by the control unit (104) for each of the droplets. Images are taken for each step of the assay. According to an example embodiment, a plurality of droplets is displaced to predetermined locations. The paths for each droplet are designed individually and globally. According to an example embodiment, the paths of the plurality of droplets are calculated such that: 1) the number of reused electrodes is minimized and 2) the overall time for the displacement of the plurality of droplets is minimized. The efficiency of the displacement of the droplets is maximized and at the same time avoids premature electrode degradation, i.e., hysteresis, permanent charging, from being use too much in a short time.

According to an example embodiment, the locations of each of the droplets are captured in the images and the target location of the droplets are predetermined as the first step. The movement path of each droplet in a droplet group is designed as a second step. The total movement time, the number of reused electrodes and the number of reusing times of each electrode are calculated as a third step. The second and the third steps are operated repetitively as iteration for different movement paths for each droplet and consequently the time and electrode reusing information may change in the iteration. The repetition is ended when a desired path strategy is achieved such as where the time and electrode reusing situation is not improved anymore.

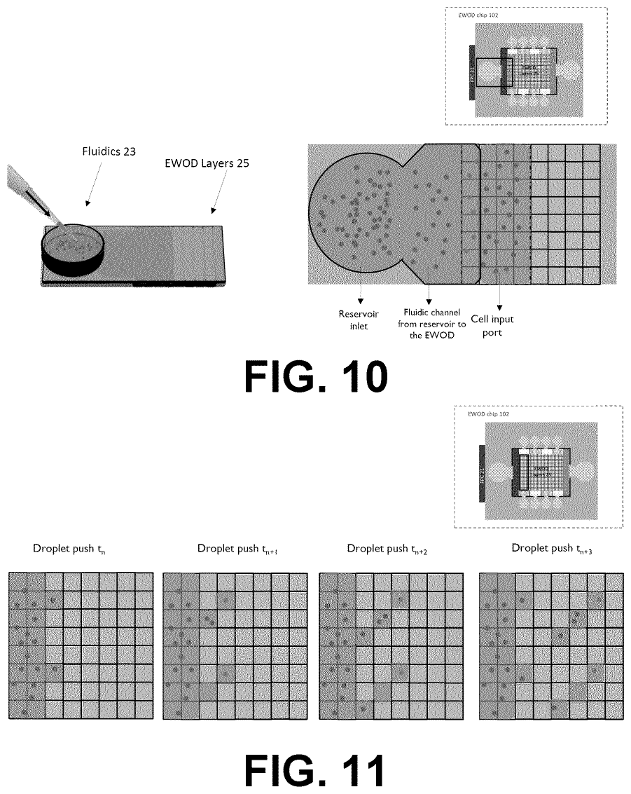

According to an example embodiment, the control unit (104) is configured to generate droplets comprising an object. After a solution containing hundreds of thousands of objects in the range of approximately 1-100 microliters is loaded to the cartridge fluidics, a predefined region of the operation space in the EWOD chip is activated to further load the solution into several columns of the electrode array as shown in FIG. 10. A certain volume of the solution is thus present on the EWOD chip. As shown in FIG. 11, a unit cell of m×n electrodes is activated to create droplets from the predefined region where the solution with objects is present. According to an example embodiment, n is 3. The unit cell can be repeatedly activated on the EWOD layer in columns to have parallel operation of generation of droplets. A row of electrodes is present between the unit cells. At each such operation sequence, columns of generated droplets are moved to the next column of electrodes and new droplets are generated in a column. Thus, more than one droplet can be generated in parallel. According to an example embodiment, the unit cells of droplet generation can change to different electrodes in order to prevent wearing of the electrodes due to repeated action of droplet generation. With a realistic design of row size of 400 electrodes and a frame rate of 10 Hz, it is feasible to generate hundreds of single droplets per second from one inlet of the cartridge. In a matter of several minutes, hundreds of thousands of single droplets thus can be created on the EWOD chip.

Some defects on an EWOD chip are not visible directly in the captured images. The system can be used for quality check of the EWOD chip, especially suitable for the non-visible defects, using electro-optic effects in droplets. According to an example embodiment, at least one droplet containing electro-optic materials that are sensitive to an electric field is introduced to the EWOD chip in operation. When the EWOD electrode contacting the droplet is activated, a contact angle change between the EWOD chip and the droplet is generated. The change of effective permittivity will result in a change in hologram pattern of the droplet by the lens free imaging device. The relative change of permittivity can be used as a feature to test whether the EWOD electrode is functioning within specification. If the relative change of permittivity is not within a predetermined margin, the subsequent control signals for all droplets will be adapted to avoid using the electrode. It is an advantage that it eliminates the need for additional electric sensing circuitry to detect hardware issues. The gain in terms of circuit area can be used for other useful features such as a larger capacitor to obtain faster actuation of droplets. Another advantage is that such test can be used periodically to see the evolution of the circuit reliability with a single or several images. A third advantage is that it can be read quickly and data can be obtained easily. No additional hardware complexity is required. According to an example embodiment, the quality check can be operated before the manipulation of droplets of interest. According to an example embodiment, the quality check can be operated during the manipulation of droplets of interest.

In the fourth and the fifth aspect, the invention is also related to a computer program and a computer-readable medium stored thereon. The computer program executes the described method in the instrument (100) or the system. The instrument (100) saves all the experimental data and analysis results of an experimental operation of droplets to a local disk or upload it to a cloud storage. According to an example embodiment, the instrument (100) further comprises a user interface informing the user about the progression of the experimental operation, instructing the user to follow certain steps and receiving inputs from the user related to the details of the experiment. All the information available per experiment is accessible to the user in a timely manner.

1. An instrument for droplet manipulation comprising:
a driving module configured for receiving control signals and for operating an electrowetting-on-dielectric chip, wherein the electrowetting-on-dielectric chip is configured for manipulating a droplet;
a droplet detection system comprising a light source and a lens-free imaging device configured for obtaining at least one image comprising the droplet in the electrowetting-on-dielectric chip; and
a control unit configured for receiving the at least one image from the droplet detection system and for sending control signals to the driving module,
wherein the control unit is further configured to adapt at least one of the control signals as a function of the at least one image.

2. A system comprising:
an electrowetting-on-dielectric chip; and
an instrument for droplet manipulation, the instrument comprising
a driving module configured for receiving control signals and for operating the electrowetting-on-dielectric chip, wherein the electrowetting-on-dielectric chip is configured for manipulating a droplet,
a droplet detection system comprising a light source and a lens-free imaging device configured for obtaining at least one image comprising the droplet in the electrowetting-on-dielectric chip, and
a control unit configured for receiving the at least one image from the droplet detection system and for sending control signals to the driving module. wherein the control unit is further configured to adapt at least one of the control signals as a function of the at least one image, and wherein the electrowetting-on-dielectric chip in a replaceable cartridge is configured to receive signals from the driving module.

3. The system according to claim 2, wherein the at least one of the adapted control signals is for instructing the driving module to move the droplet to a predetermined location.

4. The system according to claim 2, wherein the control unit is configured to extract a location of the droplet from the at least one image, wherein the at least one of the control signals is adapted based on the location.

5. The system according to claim 4, wherein the control unit is configured to adapt at least one of the control signals so if movement of the droplet differs from a predetermined first path after a first control signal, a subsequent control signal is sent to move the droplet along a second path to the predetermined location.

6. The system according to claim 2, wherein the at least one image comprises a holographic image.

7. The system according to claim 2, wherein the at least one image comprises a two-dimensional image or a three-dimensional image.

8. The system according to claim 2, wherein the control unit is configured to adapt at least one of the control signals as a function of at least one variable obtained by the control unit from the at least one image, the at least one variable representing a property of one or more of a size, shape, spectral absorbance, spectral transmittance, turbidity, viscosity, and a spatial distribution of the droplet.

9. The system according to claim 2, wherein the at least one of the control signals is adapted for instructing the driving module to mix at least two droplets into one droplet.

10. The system according to claim 2, wherein the control unit is configured to adapt at least one of the control signals as a function of at least one variable obtained by the control unit from the at least one image.

11. The system according to claim 20, wherein the object is a cell, an air bubble, or a different non-soluble droplet.

12. The system according to claim 2, wherein the control unit is configured to adapt at least one of the control signals as a function of at least one variable obtained by the control unit from the at least one image, each of said at least one variable representing a defect in the electrowetting-on-dielectric chip.

13. The system according to claim 6, wherein the electrowetting-on-dielectric chip comprises a plurality of electrowetting-on-dielectric layers, wherein the control unit is configured to adapt at least one of the control signals as a function of at least one variable obtained by the control unit from a plurality of holographic images by using focus adjustment, each of the at least one variable representing whether a droplet is present in a different electrowetting-on-dielectric layer.

14. A method for droplet manipulation via an instrument for droplet manipulation, the instrument including:
a driving module configured for receiving control signals and for operating an electrowetting-on-dielectric chip, wherein the electrowetting-on-dielectric chip is configured for manipulating a droplet,
a droplet detection system comprising a light source and a lens-free imaging device configured for obtaining at least one image comprising the droplet in the electrowetting-on-dielectric chip, and
a control unit configured for receiving the at least one image from the droplet detection system and for sending control signals to the driving module, wherein the control unit is further configured to adapt at least one of the control signals as a function of the at least one image,
the method comprising:
receiving, via the control unit, the at least one image comprising a plurality of droplets; and
generating, via the control unit, control signals for manipulating the droplets substantially simultaneously via electrowetting as a function of the received at least one image.

15. A computer program comprising instructions to cause the instrument according to claim 1 to execute the steps of the method of claim 14.

16. A computer-readable medium having stored thereon the computer program of claim 15.

17. The system according to claim 2, wherein the at least one image comprises a three-dimensional image.

18. The system according to claim 5, wherein the second path is different from the predetermined first path.

19. The system of claim 9, the control unit is configured to adapt at least one of the control signals to mix the droplets as a function of at least one variable obtained by the control unit from the at least one image, the at least one variable representing a spatial distribution of a property of one or more of a size, shape, spectral absorbance, spectral transmittance, turbidity, and viscosity of the droplet.

20. The system according to claim 10, wherein each of the at least one variable represents an object in the droplet.
